(19) United States
(12) Patent Application Publication
(10) Pub. No.: US 2019/0294397 A1
(43) Pub. Date: Sep. 26, 2019

(54) SYSTEMS AND METHODS FOR CUSTOMIZED PRODUCTION OF RECEIPTS WITH TRANSACTIONAL AND PROMOTIONAL CONTENT

(71) Applicant: Central Technology, Inc., Avon, IN (US)

(72) Inventor: Kenneth Czapla, Plainfield, IN (US)

(73) Assignee: Central Technology, Inc., Avon, IN (US)

(21) Appl. No.: 16/359,428

(22) Filed: Mar. 20, 2019

Related U.S. Application Data
(60) Provisional application No. 62/645,642, filed on Mar. 20, 2018.

(51) Int. Cl. G06F 3/12; G06Q 30/02; H04N 1/00

(52) U.S. Cl. CPC G06F 3/1263; G06Q 30/0269; H04N 1/0044; G06F 3/1206; G06F 3/1205; G06Q 30/0255

(57) ABSTRACT

Producing a checkout transaction receipt for loaned media materials, such as in a library, includes storing in a first printer queue a basic print job, determining whether the basic print job is a raw type file or a non-raw type file, and triggering filtering of the basic print job based on a determination that the basic print job is a raw type file. Production of the transaction receipt also includes producing customized print job populated with transaction content based on checkout transaction data and custom content including promotional content based on stored custom content file(s). The customized print job is stored in a second printer queue, and printed to a transaction receipt printer or electronically generated for access by a patron. The strategy enables manipulation of receipts for adding promotional content without any need for additional hardware and regardless of preexisting institutional processes or computer systems that are in place.

### CROSS REFERENCE TO RELATED APPLICATIONS

This application claims priority under 35 USC § 119(e) to U.S. Provisional Patent Application No. 62/645,642 filed Mar. 20, 2018 and titled Systems and Methods for Customized Production of Receipts with Transactional and Promotional Content, the disclosure of which is incorporated by reference herein.

### TECHNICAL FIELD

The present disclosure relates generally to a computer-implemented strategy and system for populating library transaction receipts with promotional content, and more particularly to processing print jobs in such a system based on whether a print job is a raw type file or a non-raw type file.

### BACKGROUND

Many municipal institutions such as libraries face challenges in the current economic environment, including higher operating costs, competition, reduced patron interest and engagement, and other factors leading to declining revenues. Libraries also face challenges when it comes to simply promoting the library itself. Modern libraries are more than simply lending institutions, and are rapidly becoming community hubs for workshops, classes, seminars, meeting places for local non-profit groups, hands-on experience in 3D printing to name a few examples. While library websites often showcase various events, there are challenges relating to engaging patrons, and actually getting information to patrons amidst the multitude of distractions in the modern, increasingly digital world. Patrons and potential patrons are often unaware of library programming or events supported by outside groups or persons. Informational material disseminated by phone, email, or text, as well as website or social media-promoted content is commonly ignored or never even encountered by patrons or potential patrons. For these and other reasons, interest in the library industry for new mechanisms and channels for informing the patron community of library services and offerings remains strong.

Some libraries have attempted to increase patron awareness and revenues by opening their doors to sponsorships by corporations or private citizens in exchange for branding rights or naming rights, for example. There tends to be a relatively low return on investment for such endeavors and, moreover, the libraries' own rules and policies not to mention tax regulations can be implicated.

Would-be corporate sponsors have made various attempts to resolve the challenges that lending institutions face. In one known strategy set forth in U.S. Pat. Nos. 8,407,062 and 7,890,337 a library user is apparently rewarded for checking out materials based on their reading interests. Commercial intrusion is often considered antithetical to the library mission. Compounding this problem can be the additional technical and information technology burdens associated with running multiple different computer systems and hardware systems needed for implementing third party systems. Moreover, providing advertising content for third parties fails to assist libraries in promoting their own content, and can even distracts patrons from attempts by the library at self-promotion.

### SUMMARY OF THE INVENTION

In one aspect, a method of producing a checkout transaction receipt for loaned media materials includes storing in a first printer queue a basic print job containing checkout transaction data for an item of tangible media, and determining whether the basic print job is a raw type file or a non-raw type file. The method further includes triggering filtering of the basic print job based on a determination that the basic print job is a raw type file, and producing a customized print job populated with transaction content that is based on the checkout transaction data and custom content that is based on a stored custom content file. The method still further includes storing in a second printer queue the customized print job, and printing the customized print job at a transaction receipt printer for pickup by a patron.

In another aspect, a system for processing transactions in a lending institution includes a network of computers including at least one computer structured to communicate with each of an ILS server and an FTP server, and a receipt printer coupled with the at least one computer. The at least one computer is further structured to store in a first printer queue a basic print job containing checkout transaction data for an item of tangible media, and determine whether the basic print job is a raw type file or a non-raw type file. The at least one computer is further structured to filter the basic print job based on a determination that the basic print job is a raw type file, and produce a customized print job populated with transaction content that is based on the checkout transaction data and custom content that is based on a stored custom content file. The at least one computer is still further structured to store in a second printer queue the customized print job, and command printing the customized print job at the receipt printer.

In yet another aspect, a system for processing lending transactions includes a network of computers including at least one computer structured to communicate with a plurality of servers and a receipt printer. The at least one computer is further structured to store in a first printer queue a basic print job containing checkout transaction data for an item of tangible media, and determine whether the basic print job is a raw type file or a non-raw type file. The at least one computer is further structured to filter the basic print job based on a determination that the basic print job is a raw type file, and produce a customized print job populated with transaction content that is based on the checkout transaction data and custom content that is based on a stored custom content file. The at least one computer is still further structured to store in a second printer queue the customized print job, and command outputting the customized print job as one or more of a printed receipt or a text (SMS).

### BRIEF DESCRIPTION OF THE DRAWINGS

FIG. 1 is a schematic illustration of a system, according to one embodiment;

FIG. 2 is a flowchart illustrating example methodology and control logic flow, according to one embodiment;

FIG. 3 is a block diagram illustrating example processing of print jobs, according to one embodiment;

FIG. 4 is an example promotional receipt layout, according to one embodiment;

FIG. 5 is a diagrammatic illustration of certain features and functions of a user interface, according to one embodiment;

FIG. 6 is a diagrammatic illustration of other features and functions of a user interface, according to one embodiment;

FIG. 7 is a diagrammatic illustration of still other features and functions of a user interface, according to one embodiment;

FIG. 8 is a diagrammatic illustration of still other features and functions of a user interface, according to one embodiment; and

FIG. 9 is a flowchart illustrating example methodology and control logic flow, according to one embodiment.

### DETAILED DESCRIPTION

The present disclosure includes methods for increasing library program awareness and attendance by delivering promotional content relevant to a patron's age group and/or subject interests via a checkout transaction receipt. The checkout receipt is a medium that the patron will save and refer back to in order to review the return due dates of the items that they have checked out. This almost makes certain that whatever promotional content is printed on the receipt, will likely be viewed by the patron, possibly multiple times.

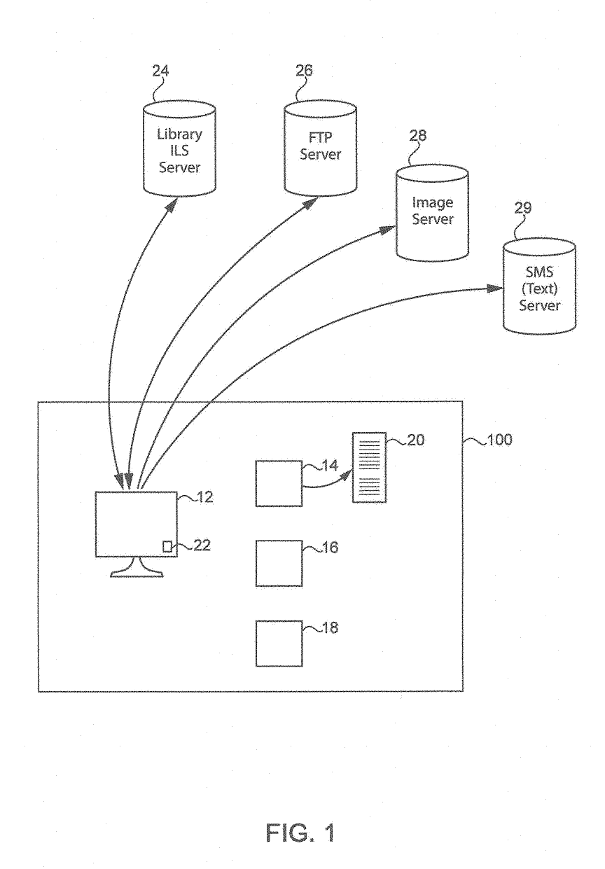

Referring to FIG. 1, there is shown a system 100 according to one embodiment for processing checkout transactions in a library or other lending institution, and producing checkout transaction receipts for loaned media materials that are customized to contain transaction content and promotional content. System 100 includes a library workstation 10 which could be a library staff circulation workstation or a self-checkout station, for example. Workstation 10 can include a computer 12, a receipt printer 14, a scanner 16 such as a laser scanner structured to scan barcodes on tangible media materials such as books, magazines, CDs (Compact Discs), tapes, DVDs (Digital Versatile Discs), or still others. Workstation 10 further includes an RFID (Radio Frequency Identification) reader/antenna 18 structured to read an RFID tag, label or the like on an item of tangible media or a container for an item of tangible or intangible media. RFID reader 18 can also be structured to unlock a security bit in an RFID security tag or the like. Various other barcode readers, QR code (Quick Response Code) readers or scanners, security case unlockers, and still other devices could be included as part of workstation 10. A printed receipt is shown at 20. A software application 22 is shown installed on computer 12. As will be further apparent from the following description, software application 22 can be structured to customize receipt 20 with transactional content and promotional content in a manner contemplated to provide advantages over known promotional content/advertising strategies, and with minimal need for investments in upgraded infrastructure, staff training, or commercial intrusion.

System 100 further includes an ILS (Integrated Library System) database server 24 used to store patron and item records, checkout transactions, and other administrative information for operating a library. System 100 also includes an FTP (File Transfer Protocol) server 26 that stores customer account settings and custom receipt templates used by software application 22 as further discussed herein. Those skilled in the art will be familiar with the communication that takes place between a staff computer workstation or a self-checkout station and a library ILS server to effectuate checkout of an item of tangible media. For such purposes, computer or processor 12 can communicate with library ILS server 24 according to the well-known SIP-2 protocol. For purposes of communicating with FTP server 26 the common file transfer protocol may be used. Servers discussed herein could be stand-alone computer servers, multiple servers integrated into one machine, could-based servers or services, web servers, or still others. It is also contemplated that system 100 can include multiple computer workstations such as multiple self-checkout stations, and multiple staff workstations at circulation desks. The various computer workstations can be at a single library branch, or at several different library branches, all capable of communicating with library ILS server 24, FTP server 26, and the other servers contemplated here in. In a practical implementation strategy each of server 24 and server 26 may be accessible by all computers (and/or users) that are appropriately credentialed within a library's computer network. FTP server 26 stores configuration files for software application 22, and also stores promotional content to be further discussed herein that is accessed by computer 12. It is also contemplated that one or more than one of the computers in the library's computer network can be structured to manipulate files on FTP server 26. In one implementation, periodically, such as once an hour, all computers in the computer network may update by downloading new files, if any exist, from FTP server 26. When customized receipts are produced according to the present disclosure, each of the receipts can be constructed based upon the most recently updated/downloaded promotional content on the local computer such as computer 12. Communicating with FTP server 26 each time a receipt is to be constructed to retrieve promotional content would nevertheless be a strategy that falls within the scope of the present disclosure. Optionally system 100 may further include an image server 8 capable of storing images of the generated receipts in a desired image file format (jpeg, gif, pdf, bmp, tiff, and the like). System 100 may also include a text (SMS) server 9 for generating and sending a text message to a patron containing a message directing them how to retrieve an electronic version of their receipt (e.g., by clicking on a hyperlink using a smartphone or other device to retrieve an image of the receipt from an image server).

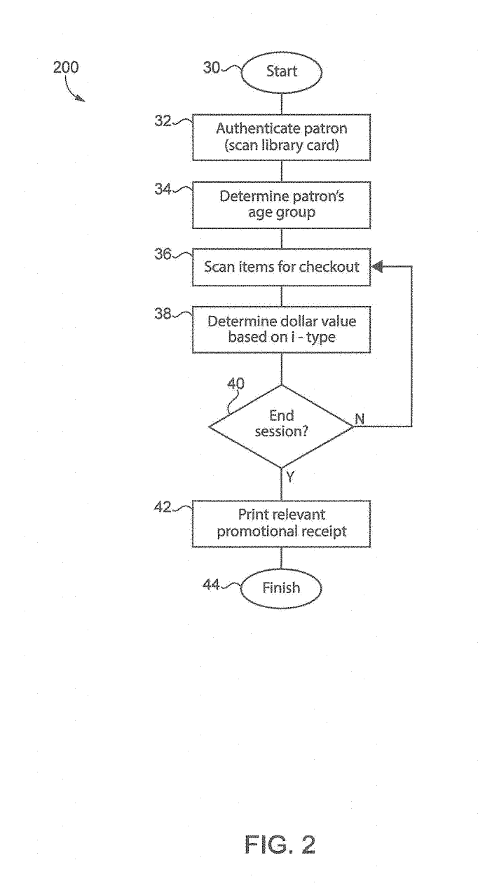

Referring now to FIG. 2, there is shown a flowchart 200 according to one embodiment, and illustrating process and control logic flow. At block 30 processing of a checkout transaction can start, with the process advancing to block 32 to authenticate the library patron, such as by scanning a library card or other identification. From block 32, the process can advance to block 34 to determine a patron's age group. A patron might be classified as a child, young adult, or adult. As further discussed herein promotional content can be provided based at least in part upon the patron's determined age group. From block 34 the process can advance to block 36 to scan items, including items of tangible media, for checkout. From block 36 the process can advance to block 38 to determine a monetary value or other value such as a rewards points value based on i-type code associated with the item. From block 38, the process may advance to block 40 to query “end session?”. If no, the process may return to scan additional items for checkout at block 36, If yes, the process can advance to block 42 to print a relevant/corresponding promotional receipt, as further discussed herein. From block 42 the process can advance to block 44 to finish.

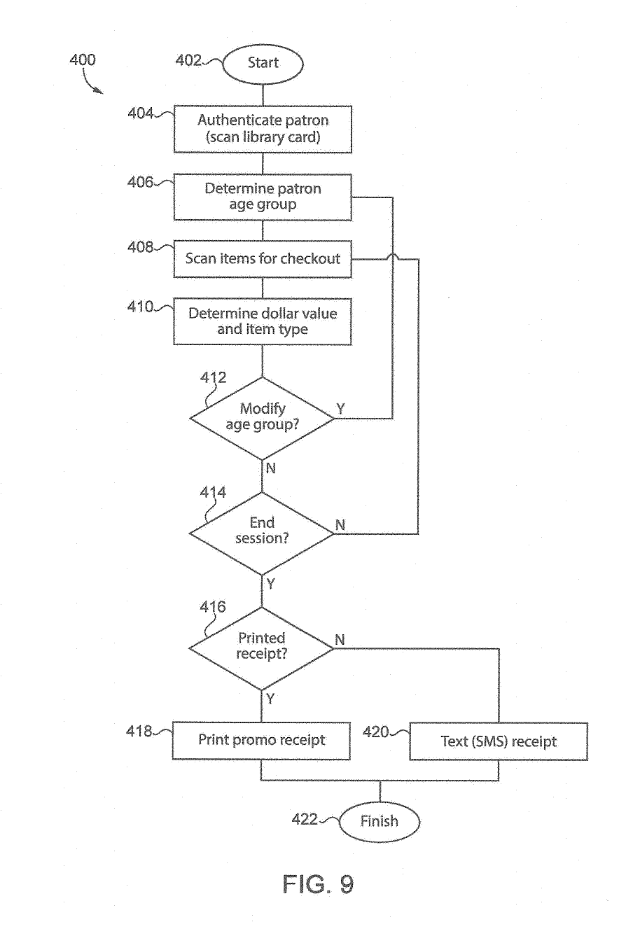

Referring now to FIG. 9, there is shown a flowchart 400 according to one embodiment, and illustrating process and control logic flow. At block 402 processing of a checkout transaction can start, with the process advancing to block 404 to authenticate the library patron, such as by scanning a library card or other identification. From block 404, the process can advance to block 406 to determine a patron's age group. A patron might be classified as a child, young adult, or adult, for example. In other examples age classifications may be divided by age ranges (e.g., 2-6, 12-14, 18-30, etc.). As further discussed herein promotional content can be provided based at least in part upon the patron's determined age group. From block 406 the process can advance to block 408 to scan items, including items of tangible media, for checkout. From block 408 the process can advance to block 410 to determine a monetary value or other value such as a rewards points value based on i-type code associated with the item. From block 210 the process may advance to query if the user wishes to modify the age group based on the material the patron has selected. For example, if a patron classified as “adult” is checking out material categorized as “child” then the promotional receipt generated by the transaction may be one normally received by a child. Such a determination may be made automatically (for example, if the number of items checked out which are categorized as an age group other than the age group of the patron exceeds a predetermined threshold) or manually by the user at checkout. From block 412, the process may advance to block 414 to query “end session?”. If no, the process may return to scan additional items for checkout at block 408. If yes, the process can advance to block 416 to query if the patron wishes to have a paper receipt printed (which would advance to block 418 and print a paper receipt) or the patron wishes to have an electronic receipt generated (which would advance to block 420 and generate an electronic, text (SMS) receipt). Both block 418 and 420 would then advance to block 422 to end the transaction.

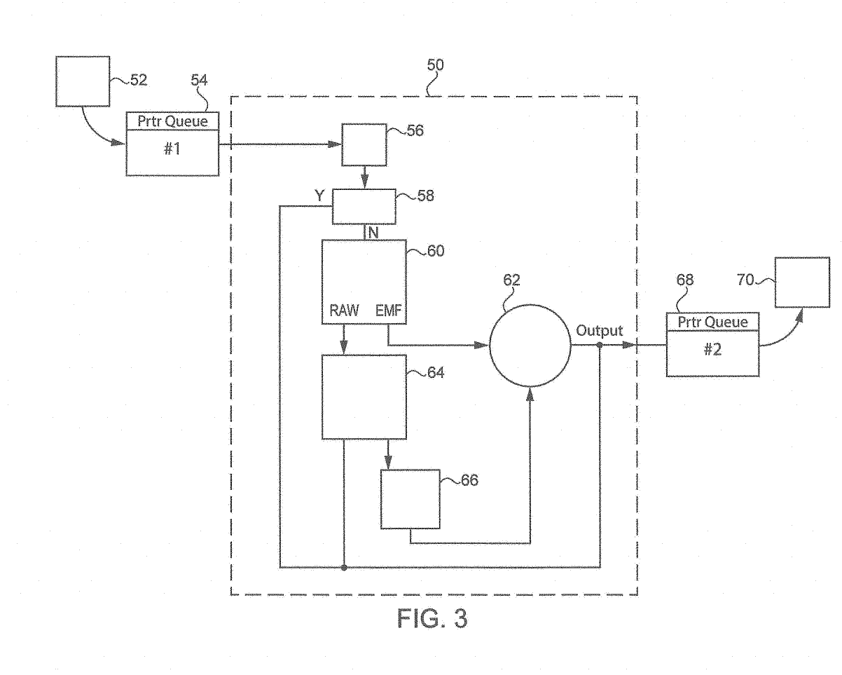

Referring now to FIG. 3, there is shown a method to convert original receipt data or a “basic receipt” into a customized receipt. Block 52 shows a computer workstation such as a library circulation staff workstation, or potentially a self-checkout station running software such as software application 22. Computer workstation 52 can execute a checkout transaction with, for example, a staff member clicking print to place a basic print job in printer queue 54. Printer queue 54 can store, at least temporarily, the basic print job on computer workstation 52. The basic print job in printer queue 54 can contain checkout transaction data for an item of tangible media, including such data as the item identification, date, time, patron identification, rewards value, and still other conventional checkout transaction data. Printer queue 54 and/or the associated computer workstation may be structured to print all print jobs stored therein to file. Accordingly, according to the present disclosure at a block 56 the basic print job can be observed printed to a designated folder.

When the basic print job is observed in a folder at block 56, the software application can commence processing the basic print job into a customized print job. The print data in the basic print job printed to the folder at 56 can include print data in the form of a .prn file. The basic print job can then be sent to a switch shown at block 58. The switch at block 58 provides a staff member the opportunity to send a print job directly to a receipt printer with no custom graphics or custom text in the nature of promotional text added. Simple hold slips might be printed, for example. Switch 58 can be controlled by pressing a function key on or at computer workstation 52, for example. If the function key is pressed the print job can be sent directly to the receipt printer. If not pressed, transaction print data can be interrogated at block 60. At block 60 it is determined whether the basic print job is a raw type file or a non-raw type file. A raw type file could be, for example, a simple print screen file with no formatting. A non-raw type file could be a basic print job with formatting such as an EMF (Enhanced MetaFile) file. Subsequent processing according to one of two available processing paths can be triggered based upon whether the basic print job is a raw type file or a non-raw type file.

In particular, filtering of the basic print job can be triggered based on a determination that the basic print job is a raw type file. If the basic print job is a raw type file, at block 64 the raw print data is sent to a configurable switch 64 that determines whether raw print files are to be processed to include promotional content or not. Library staff can set the switch at block 64 to operate in one of two ways, either adding promotional content to raw print files or not adding promotional content to raw print files. If switch 64 is set to send the raw print data directly then the raw print data can be forwarded to a second printer queue 68 directly for printing. If the switch at block 64 is set to process raw print data to include promotional content, then the raw print data can be sent to a filter at block 66. The filter at block 66 can be understood to clean up commands that go with raw print data, including escape codes such as form feed codes, cut codes, and other printer language codes. The filter at block 66 can thus be understood to strip the escape codes off, after which the stripped print file can be forwarded to a receipt processor at block 62. A non-raw type file from block 60 could be forwarded to the receipt processor at block 62 without filtering, as depicted in FIG. 3. It will thus be appreciated that the receipt processor at block 62 can produce a customized print job based on either a raw type file or a non-raw type file.

The operations at the receipt processor at block 62 can further be understood to populate a customized print job with transaction content that is based on the checkout transaction data and custom content that is based on a stored custom content file. It will be recalled that stored custom content files can be stored at FTP server 26, and periodically downloaded to local computer stations. The receipt processor at block 62 will therefore assemble a customized receipt, and send the receipt as a customized print job to second printer queue 68, for printing at receipt printer 70. It should further be appreciated that the producing of a customized print job can include producing a plurality of separate print jobs in series. In other words, rather than inserting cut codes or other commands, between pieces of transaction content or custom content, the customized print job can actually include separate print jobs sent to printer queue 68 in series. It will be appreciated that the stored custom content files can include image files or text files, for instance, and receipt processor 62 can therefore be thought of as assembling a series of different files to be printed on the customized receipt in a prescribed manner. A graphical user interface can be provided that creates a virtual receipt canvas where library staff can vary the promotional content, or vary the arrangement or layout of the promotional content. In another embodiment, the checkout receipt is processes by forwarding it to a Virtual Printer driver which converts the receipt into XML, or text with positioning format. The converted file is then rendered with promotional content.

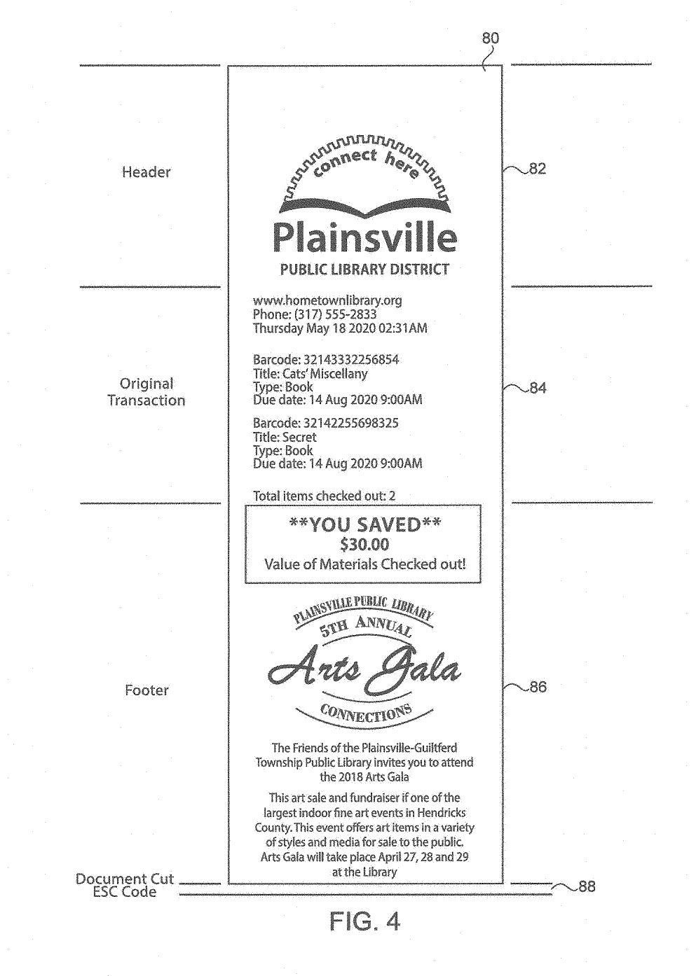

Referring now to FIG. 4, there is shown a promotional receipt 80 that includes a header at 82, an original transaction or transaction data at 84, and a footer at 86. It will be appreciated that a conventional checkout receipt could include merely transaction content 84. The present disclosure provides the opportunity to combine the original transaction content 84 with a custom content file such as the custom content shown at 86 and potentially custom content in the header at 82. A document cut is shown at 88. Various other arrangements of the promotional content and transaction content are contemplated within the present context.

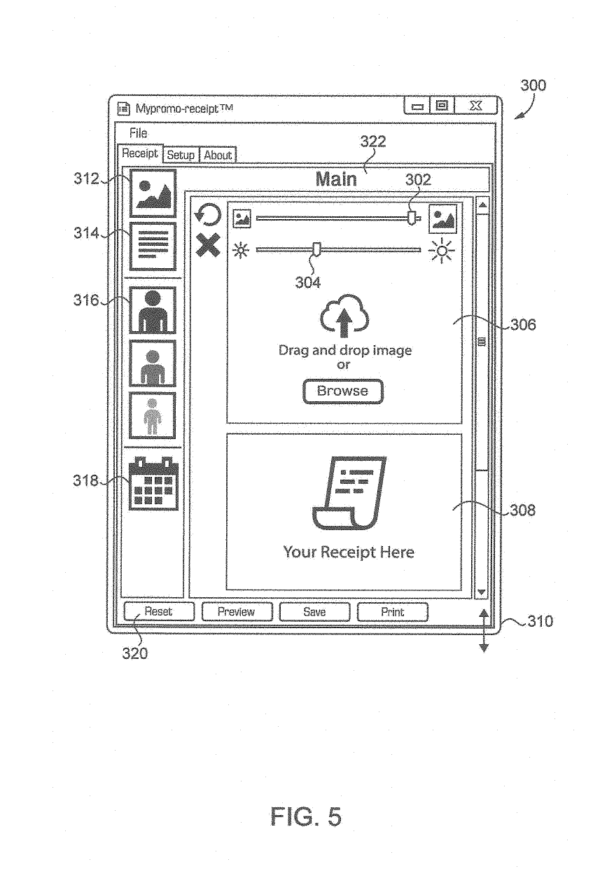

Referring now to FIG. 5, there is shown an example of a user interface 300 illustrating various features that can be manipulated to provide a customized receipt. On the left-hand side are shown controls to add a new image 312 to a receipt canvas 322, add new text 314 to a receipt canvas 322, create an age-specific promotion 316, or set an expiration date of a promotion 318. The receipt can also be reset to a saved copy and/or a default template 320. On the right-hand side can be seen a scale image slider 302, a brightness slider 304, an image box 306 (shown as empty in this example), and the position that a standard checkout receipt will appear on a custom receipt 308. Optionally, the interface further includes a slider bar 310 to allow the user to move or expand the current view of the receipt canvas 322.

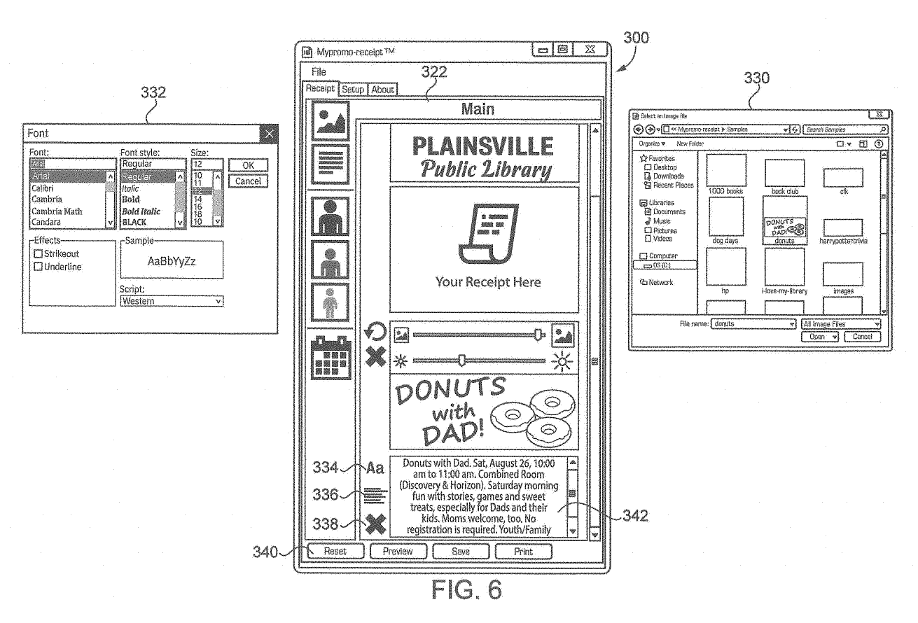

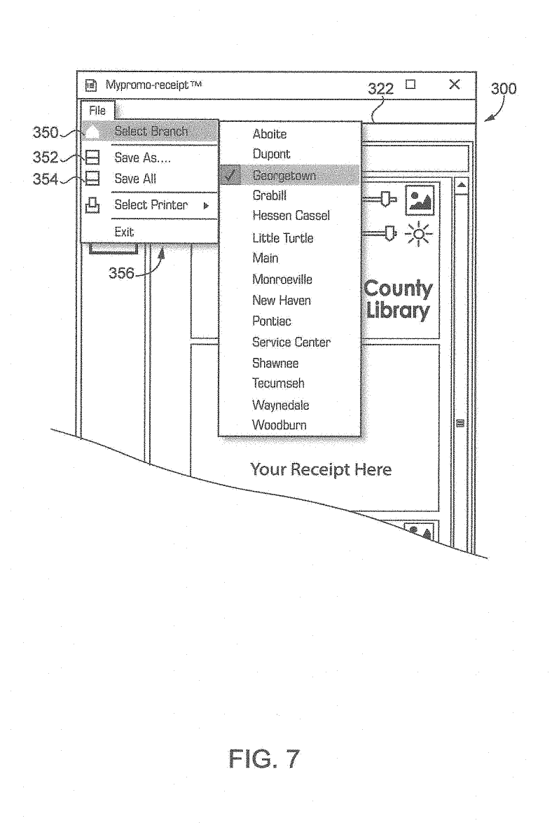

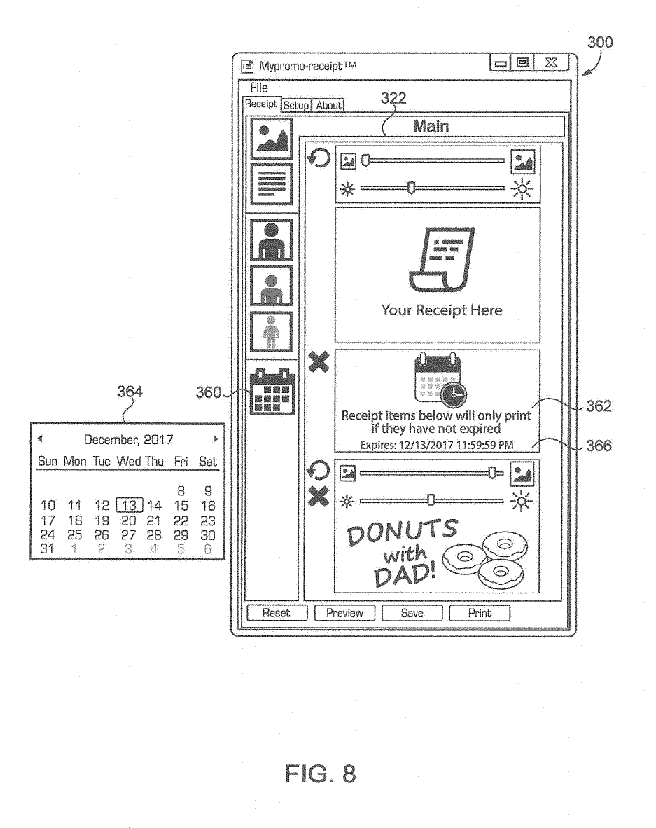

Referring now to FIG. 6, there is shown an example of a graphical user interface 300 with a dialog box 332 shown on the left-hand side that might be generated to edit custom text 334. Also shown are controls to justify text 336, delete a box 338, or reset a recent change 340. Another window is shown at 330 whereby a user can drag or double-click a selected graphic into the image box. Optionally, the interface further includes a slider bar 342 to allow the user to move or expand the current view of the receipt canvas 322. Referring to FIG. 7, there is shown graphical user interface 300 where a dropdown menu is shown at 356 that provides a user selection such as load and create/edit a custom receipt for selected library branches 350, save a custom receipt to an individual library branch 352, or save custom receipts to all library branches 354. FIG. 8 illustrates graphical user interface 300 as it might appear where setting a promotion to automatically expire. At number 360 are shown the instructions to click the calendar icon 364 and to next schedule the month/day that promotional content is to expire. At numeral 362 an expiring box is shown to appear, informing a user as to expiration of the items. Optionally, the interface further includes a slider bar 366 to allow the user to move or expand the current view of the receipt canvas 322.

Optionally, the system nay also include features which allow for queuing multiple promotions and/or rotation of promotions during a given time period. For example, multiple promotions for a particular age category may be generated so as to include an expiry condition. When a first promotions expiry condition is satisfied (e.g., a specific date/time, or a specific number of promotions issued) a second promotion automatically replaces the expired first promotion. The second promotion may also include an expiry condition. In other examples, a first a second promotion may alternate between generated receipts. In still other examples, promotions may be tied to specific media checked out by a user (e.g., only for receipts which include at least one DVD, only for receipts which include media related to cats, etc.), to specific library work stations, to patrons which live in a specific area, or any combination thereof.

The system may further include features which allow for the collection, storage, sorting, and display of statistical data relating to the system. Such data may include total number of promotional receipts generated, receipts generated by patron age category, by library station, by method of delivery (paper or electronic), by category of media checked out by patrons, and combinations thereof. The data may be accessed by management or supervisors using a computer connected to a library server and/or by a portable device such as a tablet or smartphone.

From the following description it will be appreciated that the present disclosure enables a library or other lending institution to provide promotional content on receipts for checkout transactions without requiring a separate promotional coupon system, additional hardware, or other burdens to infrastructure or staff resources. Certain libraries may process receipts for checkout transactions one way only, or in multiple ways. For example, some libraries process and print receipts for checkout transactions only as raw type files, in other words only bare-bones receipts with the basic transaction data are produced. Other libraries have systems that process checkout transaction receipts as EMF files only. Still other libraries process checkout transaction receipts both ways. Software in systems of the present disclosure can function to provide promotional content regardless of a library's native systems and strategies for producing checkout transaction receipts. In addition, the present disclosure provides a platform whereby multiple different branches can be managed from a single computer workstation, with the ability to create branch-specific promotional receipts. Custom receipts for multiple available age groups can also be produced with targeted customized promotional content. Printed receipts can further include the total S amount of all items checked out during a given session with item value being determined using actual purchase price, or based on the American Library Association's value calculator, for example. It will also be appreciated that automatically expiring certain promotional content will provide advantages over the need for manual intervention that might otherwise be required. Finally, while a principal focus of the present disclosure can be providing content relevant to activities or programming at a library itself, content relating to outside sponsors, coupons, local municipal events or festivals, library closures or still other information could be provided.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. For instance, while much of the present description focuses on libraries, it should be appreciated that other lending institutions, such as an equipment rental establishment that loans tools, machinery, or even event equipment such as tents, tables, or chairs, could benefit from application of the present disclosure. Thus, the terms loan, lending, or like terms can be understood in the present context to contemplate commercially motivated rentals of equipment or the like in at least certain instances. A patron at such an establishment could receive a customized printed or digital receipt populated with promotional or other informational content for the establishment or partner businesses, for instance. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open ended terms. Further, the phrase “based on” is intended to mean “based, at least in part, on” unless explicitly stated otherwise.

What is claimed is:

1. A method of producing a checkout transaction receipt for loaned materials comprising:
storing in a first printer queue a basic print job containing checkout transaction data for an item of tangible media;
determining whether the basic print job is a raw type file or a non-raw type file;
triggering filtering of the basic print job based on a determination that the basic print job is a raw type file;
producing a customized print job populated with transaction content that is based on the checkout transaction data and custom content that is based on a stored custom content file;
storing in a second printer queue the customized print job; and
printing the customized print job at a transaction receipt printer for pickup by a patron.

2. The method of claim 1 wherein the stored custom content file includes at least one image file.

3. The method of claim 2 wherein the producing of a customized print job includes producing a plurality of separate print jobs in series.

4. The method of claim 1 further comprising stripping codes from the basic print job in response to the triggering of the filtering.

5. The method of claim 4 wherein stripping of codes from the basic print job includes stripping escape codes.

6. The method of claim 1 further comprising printing the basic print job to a folder, and detecting the printing of the basic print job to the folder.

7. A system for processing transactions in a lending institution comprising:
a network of computers including at least one computer structured to communicate with each of an ILS server and an FTP server, and a receipt printer coupled with the at least one computer;
the at least one computer being structured to:
store in a first printer queue a basic print job containing checkout transaction data for an item of tangible media;
determine whether the basic print job is a raw type file or a non-raw type file;
filter the basic print job based on a determination that the basic print job is a raw type file;
produce a customized print job populated with transaction content that is based on the checkout transaction data and custom content that is based on a stored custom content file;
store in a second printer queue the customized print job; and
command printing the customized print job at the receipt printer.

8. The system of claim 7 wherein the at least one computer includes a local computer structured to communicate with the ILS server and the FTP server and to store the first printer queue, and a peripheral computer structured to store the second printer queue.

9. The system of claim 8 wherein the peripheral computer includes a checkout station.

10. The system of claim 8 wherein the local computer is further structured to receive the transaction content from the ILS server and to receive the custom content from the FTP server.

11. The system of claim 7 wherein the at least one computer is further structured to strip codes from the basic print job in response to the triggering of the filtering.

12. The system of claim 11 wherein the codes include escape codes.

13. The system of claim 7 wherein the at least one computer is further structured to:
store in the first printer queue a second basic print job containing checkout transaction data for a second item of tangible media;
determine the second basic print job is a non-raw type file; and
produce a second customized print job populated with the checkout transaction data for the second item of tangible media and custom content that is based on a stored custom content file.

14. The system of claim 13 wherein the second basic print job is an EMF (Enhanced MetaFile) file.

15. A system for processing lending transactions comprising:
a network of computers including at least one computer structured to communicate with a plurality of server computers and a receipt printer;
the at least one computer being structured to:
store in a first queue a basic receipt job containing checkout transaction data for an item to be loaned out;
determine whether the basic receipt job is a raw type file or a non-raw type file;
filter the basic receipt job based on a determination that the basic receipt job is a raw type file;
produce a customized receipt job populated with transaction content that is based on the checkout transaction data and custom content that is based on a stored custom content file;
store in a second queue the customized receipt job; and
command outputting the customized receipt job.

16. The system of claim 15, wherein the customized receipt job is a printed receipt.

17. The system of claim 15, wherein the customized receipt job is a text (SMS) receipt.

18. The system of claim 15 wherein the plurality of servers includes an ILS server, and image server, a text (SMS) server, and a FTP server.
